(19) United States
(12) Patent Application Publication
(10) Pub. No.: US 2024/0100596 A1
(43) Pub. Date: Mar. 28, 2024

(54) POWDER MANUFACTURING FOR POWDER METALLURGY

(71) Applicants: Danmarks Tekniske Universitet, Kongens Lyngby (DK); Nordic Metals ApS, Frederiksværk (DK)

(72) Inventors: Venkata Karthik Nadimpalli, Kongens Lyngby (DK); David Bue Pedersen, Kongens Lyngby (DK); Jan Sørensen, Frederiksværk (DK); Jesper Bjørklund Themsen, Frederiksværk (DK)

(21) Appl. No.: 18/255,971

(22) PCT Filed: Dec. 8, 2021
(86) PCT No.: PCT/EP2021/084763

§ 371 Date: Jun. 5, 2023

(30) Foreign Application Priority Data
Dec. 8, 2020 (EP) 20212533.2

(51) Int. Cl. B22F 9/08; B22F 1/05; B33Y 80/00

(52) U.S. Cl. CPC B22F 9/082; B22F 1/05; B33Y 80/00; B22F 2203/11; B22F 2203/13; B22F 2304/10; B22F 2998/10

(57) ABSTRACT

A spray forming method for producing a metallic ingot and metallic powder from a metallic source of metal or metal alloy includes: forming one or more streams of metal or alloy from the source, gas atomizing one or more streams of metal or alloy to form one or more sprays of atomized droplets, directing the spray(s) of droplets through a spray nozzle to a rotatable hot body, depositing the droplets to the hot body to form the ingot, controlling the process parameters 1) temperature of metal or alloy, 2) inlet and outlet pressure of the spray nozzle, 3) rotation speed of the hot body, and/or 4) distance between the hot body and the spray(s) of droplets, and collecting the metallic powder having a predefined size distribution. The process parameters are controlled such that the ingot yield is 60-80% and the metallic powder yield is 40-20%, relative to the metallic source.

### CROSS-REFERENCE TO RELATED APPLICATIONS

This application is the U.S. National Stage of PCT/EP2021/084763 filed on Dec. 8, 2021, which claims priority to European Patent Application 20212533.2 filed on Dec. 8, 2020, the entire content of both are incorporated herein by reference in their entirety.

### FIELD OF THE INVENTION

The present disclosure relates to methods and systems for manufacturing a metallic ingot and a metallic powders from a metallic source of metal or metal alloy.

### BACKGROUND OF THE INVENTION

Powder metallurgy is a common denominator for a number of production technologies, in which a feedstock in powder form is processed to manufacture components of various types. These production technologies are for example isostatic pressing, metal additive manufacturing, metal injection moulding, powder soldering, laser cladding, thermal spraying, and powder sintering.

Metal powders used in powder metallurgy can be produced via a number of methods. One of the most commonly used technique to produce metal powders and powders of pre-alloyed compositions is gas atomization.

Gas atomization begins with scrap molten metal and comprises the step of interaction of the melt with an atomising gas. During the process, the impact of the high-energy atomizing gas on the melt stream results in a transfer of the impact kinetic energy from the atomizing gas to the melt, and as a result a fine dispersion of metal droplets are generated.

One of the disadvantages of this method is that the produced powders has a wide size distribution, typically following a Gaussian shape. However, depending on the powder metallurgy technology, a narrower particle size distribution may be desired.

For example, in powder sintering, fine powders with narrow particle size distribution are required in order to have a high degree of sintering activity to allow the green part to be sintered to a high density. This means that for a powder metallurgy process where small particle size and narrow particle distribution is required, powders with larger particle size cannot be utilized in the process. Gas atomization, wherein powders are produced with a wide Gaussian size distribution, therefore, can produce a high degree of scrap powders, indicating inefficient utilization of resources due to waste in energy and raw material.

Furthermore, in newer powder metallurgy technologies such as powder sintering and metal additive manufacturing, narrow and small particle size distribution, sphericity and smoothness of the powders are among the desired properties.

The gas atomizing technique is based on atomizing the metal into small droplets that solidify before they come into contact with a surface or with one another. However, during gas atomisation, many particles containing enough latent heat fuse with neighbouring particles resulting in satellites or oblate shaped particles. Formation of satellites or oblate shaped particles is another disadvantage of gas atomization as it is unwanted in the final powder product.

Although gas atomization dominates the powder metallurgy techniques for powder production, especially in new fields of powder sintering and metal additive manufacturing, there is a great demand in powder manufacturing for high quality metallic powder at a lower cost, in particular a high yield in a narrower powder range, smaller powder particle size and enhanced sphericity and smoothness properties while keeping the powder production costs at a low level.

### SUMMARY OF THE INVENTION

The present inventors have realized that producing one or more metallic powders can be achieved by a system comprising a hot body in a system similar to spray forming. Hence the present disclosure concerns manufacturing of metallic powders, which subsequently can be used in a powder metallurgy technology, such as metal additive manufacturing or powder sintering.

In the spray forming process, atomized droplets are produced by spray deposition to manufacture bulk materials, such as ingots and bars. During deposition, metal droplets containing enough latent heat are deposited while metal droplets without enough latent heat bounce off of the hot body. In the spray forming process, these particles that bounce off of the hot body are referred as over spray material and regarded as scrap. The present disclosure also relates to a realization of the new use of such over spray material that are regarded as scrap in some conventional manufacturing processes such as spray forming.

One advantage of the presently disclosed approach is the provision of the hot body. It was realized that, in a system comprising a hot body, such as an ingot in spray forming where the metal droplets bounce off of the hot body, formation of satellite- and oversized metal particles can be minimized.

Another advantage of the presently disclosed approach is that a homogenous powder size distribution, i.e. narrow particle size distribution can be obtained. This is a great advantage over conventional metal powder manufacturing techniques which typically provide a broad particle size distribution and large (mean) particle sizes.

The present disclosure therefore relates to a manufacturing method for metal powder for powder metallurgy. The metal droplets may be formed for example by atomizing the melt or stream of one or more metallic material(s). Some part of the atomized droplets are directed and collected on a substrate or on a hot body, producing a bulk material such as ingot. Another part of the atomized droplets bounces off of the hot body, producing a material in the form of a metallic powder.

In a first aspect, the present disclosure relates to a method for producing a metallic ingot and metallic powder from a metallic source of metal or metal alloy, comprising the steps of:
forming one or more streams of metal or metal alloy from the metallic source,
gas atomizing one or more streams of metal or metal alloy to form one or more sprays of atomized droplets,
directing the spray(s) of droplets through a spray nozzle to a rotatable hot body,
depositing the droplets to the hot body to form the ingot,
controlling the process parameters
i. the temperature of metal or metal alloy, and
ii. inlet and outlet pressure of the spray nozzle, and
iii. the rotation speed of the hot body, and
iv. the distance between the hot body and the spray(s) of droplets, such that

collecting the metallic powder having a predefined size distribution, wherein the process parameters are controlled such that the ingot yield is between 60% and 80% and such that the metallic powder yield is between 40% and 20% relative to the metallic source.

The interaction between the stream of metal and the atomizing unit plays a role in producing an array of droplet of various sizes and the degree of deposition of the metallic droplets onto the hot body or the substrate. Furthermore, the diameters of the metallic powder may change depending on the interaction between the atomized droplets and the hot body.

Hence, an advantage of the present disclosure is that, by altering the process parameters the temperature and the diameter of the hot body can be maintained at a predefined range as a result the ratio of bulk to metallic powder as well as the size and the distribution of powder particles can be maintained at a predefined range.

In traditional spray forming the ingot is the end product and the overspray material is considered scrap and spray forming process parameters are therefore selected to maximize the size of the ingot (relative to the source of metal), typically around 80-85% of the metal source is transformed to an ingot in traditional spray forming. In traditional gas atomization the end product is the metallic powder and process parameters are therefore selected to maximize the amount of the metallic powder. But with the presently disclosed approach the end product is both the ingot and the metallic powder and the process parameters are therefore selected to provide a suitable amount of high quality metallic powder and a suitable size of the ingot, thereby providing a reduced production cost of both the ingot and the metallic powder.

Preferably, the presently disclosed system and method can be configured such that process parameters are controlled to obtain predefined ingot to powder ratio. Specifically, in a spray forming process the process parameters can be controlled to decrease the ingot yield such that the metallic powder yield relative to the metallic source can be increased while providing a fine and homogeneous metallic powder particle size distribution.

Additionally, controlling the process parameters enables control of the powder particle size and distribution, foreseeing that, manufactured powder particles can be used in wide range of powder metallurgy applications.

Thus, the present disclosure relates, in a second aspect, to a use of a metallic powder in the application of powder metallurgy, wherein the metallic powder is manufactured by the method of the present disclosure. The present disclosure therefore contributes to a functionality of the powder that is previously regarded as a scrap material.

A further advantage of the disclosed approach is providing a bulk such as an ingot and a powder of the same metallic material. In a third aspect, the present disclosure relates to a kit, comprising a bulk material and metallic powder, manufactured by the method according to the present disclosure. This foresees that the bulk and the powder material have same chemical composition and can be further processed for using in production as mold or die parts.

Thus, present disclosure can provide a metallic powder that can be included in companies' circular economy. In industries where metal tools are used and manufactured, the challenge is, among other things, to be able to recycle worn-out metal parts. By converting them into metal powder via presently disclosed approach, the tools can be recycled as raw materials for powder metallurgy applications such as additive manufacturing, and processed further in form of for example tools and machine parts.

The metal powder production together with the production of an ingot may constitute an important circular economic model for many companies. Another important aspect of this disclosure is that worn-out steel can be returned for recycling and a new steel in form of an ingot, bar or near net shape bulk material as well as metallic powder can be manufactured.

Thus, spray forming according to the present disclosure can create the opportunity to support a circular economy through providing a scrap metal recycling ecosystem to make metal powders and ingots. Ingots made by spray-forming can have a superior microstructure compared to cast material and provide superior performance. Overspray powder from ingot manufacturing processes has until now generally been treated as an unwanted byproduct and recycled accordingly. According to the presently disclosed approach, the resulting overspray powders can demonstrate that the overspray powder consists of spherical particles with excellent flowability as required for Additive Manufacturing (AM) and Metal Injection Molding (MIM) processing. Converting scrap metal into high quality feedstock powders for AM and MIM alongside high quality ingots can constitute an excellent sustainable business case for the spray-forming process.

The present disclosure further relates to a system for producing a metallic ingot and metallic powder, comprising:
a source of metal or metal alloy,
an atomizing unit for gas atomizing one or more streams of metal or metal alloy such that one or more sprays of atomized droplets are formed,
a rotatable hot body configured to receive the spray(s) of droplets directed by a spray nozzle, such that part of the droplets adhere to the hot body to form the ingot and part of the droplets bounce off of the hot body and form powder particles,
a classification unit configured to collect metallic powder within a predefined size distribution, and
a control unit configured to control
i. the temperature of the metal or metal alloy, and
ii. inlet and outlet pressure of the spray nozzle, and
iii. the rotation speed of the hot body, and
iv. the distance between the hot body and the spray(s) of droplets.

The presently disclosed system is preferably configured to execute the methods as described herein.

An advantage of the disclosed system is that the final metallic powder can be processed in a classification unit. Preferably, the classification unit can be configured to manipulate the metallic powder particle size and Gaussian distribution range, wherein the classification unit can comprise one or more of sieving stations and/or blending stations. Stations may correspond to a first sieving of the metallic powder, a second sieving for sorting the metallic powder in accordance with the powder particle size, and blending of the powder in accordance with the predetermined ratio of one or more predefined particle sizes.

### BRIEF DESCRIPTION OF THE DRAWINGS

The present disclosure will in the following be described in greater detail with reference to the accompanying drawings:

FIG. 1a-1b illustrate the principle behind the presently disclosed system for producing metallic powder and ingot from a stream of metallic material.

FIG. 2 shows a particle size distribution of metallic powder produced with and without a hot body.

FIG. 3 shows an illustration of a sorting station and corresponding ranges of powders with respect to the particle size.

FIG. 4 shows particle size distribution of an exemplary tailored powder having at least two distribution ranges.

FIG. 5 shows an example of the powder morphology of powders manufactured according to Example—3.

FIG. 6a shows an example of spherical morphology spray formed powders.

FIG. 6b shows an example of irregular morphology spray formed powders.

FIG. 7 shows flowability of gas atomized powders and powders manufactured according to the presently disclosed approach.

FIG. 8 shows an example of a kit according to the presently disclosed approach, comprising an ingot and powder and a final product thereof.

FIG. 9 shows an example of an ingot-based component used in service and a corresponding 1:1 compatible powder used for repairing the ingot-based component.

FIG. 10 shows an example of an ingot- and powder-based component and powder used for repairing the ingot- and powder-based component, wherein the ingot and the powder in an embodiment of the present disclosure are from the same production run.

FIG. 11 shows an example of recycling an ingot- and powder-based component used in service.

### DETAILED DESCRIPTION OF THE PREFERRED EMBODIMENTS

As used herein, the term hot body refers to a main body at elevated temperature on which the atomized metallic droplets are continuously deposited. For example, during the spray forming process atomized metallic particles are deposited on a table or a substrate, forming a hot body. The hot body therefore enlarges continuously during the spray forming process.

As used herein, the term ingot refers to the final bulk material manufactured as a product of the manufacturing process of spray forming. The atomized droplets of metallic material are deposited on a hot body forming the final product of metallic ingot.

As used herein, the term powder yield and ingot yield refers to a proportion of the manufactured powder relative to an initial metallic source and a proportion of the manufactured ingot relative to the initial metallic source, respectively.

In a first aspect, the present disclosure relates to a method for producing a metallic ingot and metallic powder from a metallic source of metal or metal alloy. The method comprises a step of forming one or more streams of metal or metal alloy from the metallic source. In a further embodiment, said one or more streams of metal or metal alloy are gas atomized to form one or more sprays of atomized droplets. In a further embodiment, the spray(s) of droplets are directed through a spray nozzle to a rotatable hot body. In a specific embodiment a part of the droplets are deposited to the hot body to form the ingot. The method further comprises the step of controlling the process parameter. The process parameters may be for example the temperature of metal or metal alloy, inlet and outlet pressure of the spray nozzle, the rotation speed of the hot body, and the distance between the hot body and the spray(s) of droplets. It is preferred that the process parameters can be controlled such that the ingot yield is between 60% and 80% and such that the metallic powder yield is between 40% and 20% relative to the metallic source. In a specific embodiment, the method comprises the step of collecting the metallic powder having a predefined size distribution.

In an embodiment of the present disclosure a part of the droplets are deposited to the hot body to form the ingot and a part of the droplets form powder. In a further embodiment, at least part of the droplets bounces off from the hot body and provides contact overspray (COS) metallic powder particles. Another part of the droplets does not contact with the hot body and provides non-contact overspray (NCOS).

In a conventional spray forming, about 80-85% of the molten metal is deposited forming an ingot. The 15-20% of the molten metal is either sent to waste or collected as over spray and re-melted for re-using.

In a spray forming process, the powder yield and/or COS to NCOS ratio can be varied in accordance with process parameters. The inventors of the present disclosure observed the influence of the process parameters on the properties of the hot body, such as size of the hot body and the temperature on top of the hot body.

The combinations of various sizes (0.2-0.8 m in diameter) and temperatures (1100-1500° C.) of the hot body can produce different particle size and distribution of the overspray powders. For example,

Hot and large body leads to very fine contact overspray (COS<100 μm) and low powder yield (<15%) [COS=100%, NCOS=0%],

Cold and small body leads to high powder yield (˜50%), and large over spray (up to 400 μm) [COS˜40-50%, NCOS˜50-60%].

In the example given above, it is shown that the a finer powder particle size smaller than 100 μm is provided with a lower powder yield of 15%, whereas the larger powder yield of 50% comes with a coarser powder particle size of 400 μm and above.

An alternative example therefore can comprise a powder particle size up to 300 μm with a powder yield of at least 30% or above, such that

Optimized hot body leads to optimized powder yield (30%) and particle size distribution (up to 300 μm) [COS˜75%, NCOS-25%].

In an embodiment, the process parameters are controlled such that the ingot yield is between 60% and 80% and such that the metallic powder yield is between 20% and 40% relative to the metallic source. In a preferred embodiment, process parameters are controlled such that the ingot yield is between 68% and 72% and such that the metallic powder yield is between 28% and 32% relative to the metallic source.

In an embodiment of a spray forming process, some of the process variables, such as atomization parameters, chamber parameters, hot body parameters and melt parameters are chosen such that a stable spray forming process and an increased overspray material are provided.

Generally, atomizer parameters can influence the morphology of NCOS. Moreover, the morphology of the COS may be affected by the hot body parameters, so by selecting the parameters suitably, the morphology may be controlled.

Atomization Parameters

It should be mentioned that, the atomization parameters may change according to atomization means. Atomizing of the molten metal may be in a free-fall form such that, the molten metal is released from the bottom of a crucible, forming a stream and travelling downwards through an atomizer unit, until the molten metal is atomized at a certain point below the atomizer unit.

For example, the molten metal stream can be atomized by impinging high-speed inert gas jet. When the atomization takes place under a high-speed inert gas, the powder size distribution of the generated atomized metallic powders can change based on the type of the material used, gas to metal mass flow ratio and velocity of the inert gas in the atomization area. These parameters can have an influence on the pressure of the nozzle spray, through which the molten metal is provided.

The cross section of the nozzle may differ as to direct and modify the flow of the metallic molten metal. This foresees that the pressure at the inlet of the nozzle spray may be different from the pressure at the outlet of the nozzle spray.

In a preferred embodiment, the pressure at the inlet the spray nozzle is between 2-4 bar, more preferably between 3-4 bar. In a further preferred embodiment, the pressure at the outlet of the spray nozzle is between 12-16 bar. However, a further increase in the outlet pressure may lower gas-to-metal ratio and thus a higher amount of powders with satellites.

Furthermore, the spray nozzle can be positioned with an angle relative to the horizontal top surface of the hot body. The angle of the spray nozzle can be process dependent and lie between 15° and 90°. In a preferred embodiment, the angle of the nozzle between 80° and 90°. This foresees that when the angle is 90°, atomized metal or metal alloy can be provided vertically towards the top surface of the hot body.

Chamber Parameters

The chamber parameters are other process parameter related to the chamber in which spray forming takes place. The process window of chamber parameters can be relatively narrow and it may be preferred to maintain the chamber parameters as follows: chamber pressure between 1-10 mbar, Oxygen: 0-100 ppm, Nitrogen>99.9%.

Melt Parameters

Properties of the molten metallic material can be another variable that plays a role in manufacturing an ingot and metallic powder of predefined yield. Some of the melt parameters can for example be temperature of melt, melt pressure, amount of slag and angle of melt furnace tilt.

Preferably, melt pressure may be maintained between 1-3 bar. The amount of slag and the melt temperature may be chosen in accordance with the metallic material while maintaining the angle of melt furnace tilt between 30-90°. In an embodiment, the temperature of the stream of metal or metal alloy is between 1500° C.-1700° C., preferably between 1600° C.-1700° C., most preferably between 1675° C.-1685° C.

Hot Body Parameters

In an embodiment of the present disclosure, the hot body parameters, comprising position of the hot body in relation to the spray nozzle and the speed of the hot body are controlled in order to manipulate the powder yield relative to the metallic source.

Advantageously, the distance between the hot body and the spray(s) of droplets may be between 100 mm-300 mm. It is clear that when the hot body is closer to the nozzle spray, the more atomized metallic droplets can be deposited on the hot body surface. As a result, powder yield can decrease while the powder particle size gets finer.

In order to increase the powder yield, the distance between the hot body and the spray(s) of droplets can be increased resulting in an increase in COS and NCOS. The COS increases significantly while the NCOS increases marginally. The level of increase may depend on the other process parameters. Increasing the distance further results in coarse powder particles above 400 μm. Thus, in a preferred embodiment the distance between the hot body and the spray(s) of droplets are between 150 mm-250 mm.

In a preferred embodiment, the hot body rotates relative to the spray nozzle. When rotational speed is increased, the number of atomized particles that are deposited to the hot body decreases. However, a further increase of the rotational speed may cause an instability. In an embodiment, the rotation speed of the hot body is between 0.5 rad/s-10 rad/s, preferably between 0.5 rad/s-5 rad/s, more preferably between 1.5 rad/s-3.5 rad/s.

An advantage of the presently disclosed approach is that the hot body can displace transversally with a predefined vertical speed, such that the hot body moves downwards during spray forming. An advantage of this vertical movement towards downwards is that an enlarged processing area can be provided. Up on deposition, the hot body moves downwards and an ingot with greater dimensions such as an ingot with a larger height can be formed.

A further advantage of the vertical displacement of the hot body is that the distance between the hot body and the spray nozzle can be maintained at a predefined range, thereby a more stable process is provided. In an embodiment, the vertical speed of the hot body is between 20 mm/min-200 mm/min, more preferably between 30 mm/min-150 mm/min, even more preferably between 40 mm/min-100 mm/min, most preferably between 60 mm/min 80 mm/min.

Traditionally, the process window providing a stable process is limited. It implies that choosing one process variable may often require a limited process window of some of the other parameters. However, there are a few parameters which can be manipulated such that powder yield can be manipulated to a greater range when compared to other parameters.

For example, it may be preferred to manipulate atomization/spray pressures at the inlet and outlet of the nozzle, position of the hot body relative to the nozzle spray and the speed of the hot body relative to the nozzle. These factors play a greater role on the size of the hot body and the temperature on top of the hot body.

In an embodiment, the temperature of the hot body is between 1100° C.-1500° C., preferably between 1150° C.-1400° C., more preferably between 1150° C.-1250° C., most preferably between 1175° C.-1225° C.

In a further advantageous embodiment, the diameter of the hot body is between 0.2 m-0.8 m, more preferably between 0.3 m-0.7 m, even more preferably between 0.4 m-0.6 m, most preferably between 0.45 m-0.55 m.

Powder Particle Size

Optimized process parameters can control the adhesion of the metallic droplets with high latent heat to hot body. Furthermore, optimized process parameters can control the bouncing off the metallic droplets with lower latent heat of the hot body, avoiding the metal droplets to fuse with each other when they fall; thus, high quality metal powders with enhanced technical properties is provided.

The size of the hot body and the temperature on top of the hot body can affect the quantities and size distribution of the metallic powders and powder yield. It is an advantage of the presently disclosed approach is that powder particle size below 300 μm, more preferably below 200 μm can be provided.

A further advantage is that by the method of the presently disclosed approach, process parameters can be controlled such that the COS yield is between 60% and 75% and such that the NCOS powder yield is between 40% and 25% relative to the metallic powder. In a preferred embodiment, the COS yield is between 65% and 70% and such that the NCOS powder yield is between 35% and 30% relative to the metallic powder. The yield may depending on the adhesion of the metallic droplets with high latent heat to hot body.

The presently disclosed approach can provide a predefined powder size distribution, and for some applications, a combined powder particle size may be desirable.

Sieving

An advantage of the presently disclosed approach is that NCOS and COS powder can be collected as metallic powder and classified for further use in accordance with the industrial use.

In an embodiment, a classification unit may collect metallic powder. One advantage of the classification unit may be to obtain powder particles within a predefined size distribution. The classification may be through a mechanical separation process such as sieving, flotation, vibrational separation, filtration, centrifugation, among others. Adventagously, oblate-shaped metallic particles and satellites can be filtered out.

In an embodiment, metallic powder is sorted to obtain one or more predefined powder particle size distribution(s). The powder particle size distributions may be selected from the group of: 0-25 μm, 25-50 μm, 50-75 μm, 75-100 μm, 100-125 μm, 125-150 μm, 150-175 μm, 175-200 μm, 200-225 μm, 225-250 μm, 250-275 μm and 275-300 μm. This feature foresees that at least one powder particle size distribution range can be separated from at least a second powder particle size distribution range.

It may be desirable to combine various particle size ranges at various percentages in order to enhance the process and the final product. For example, a combination of two or more powder particle size ranges may improve the density of the final product in powder sintering. In a further embodiment, metallic powder is blended such that the metallic powder of at least one powder particle size distribution range is blended with metallic powder of at least a second powder particle size distribution range.

Applications

In one embodiment, the metallic powder is used in powder metallurgy applications such as metal additive manufacturing and/or powder sintering, wherein the metallic powder is manufactured by the presently disclosed method. The presently disclosed approach may therefore be suitable for manufacturing a metallic product using metal powder metallurgy, such as additive manufacturing or powder sintering, wherein the metal powder is manufactured according to the presently disclosed approach.

The inventors have realized that the powder is particularly suitable for additive manufacturing (rapid manufacturing/prototyping (RM/P) or 3-D printing) such as Selective Laser Sintering (SLS), Selective Laser Melting (SLM) and 3-D laser cladding, among other similar techniques. The inventors have further realized the enhanced properties of the powder such as apparent and sintered density, flowability, sinterability, compressibility, etc., for using in application of additive manufacturing and powder sintering techniques. Especially in additive manufacturing, the surface roughness of the finished part can be mostly influenced by the powder particle size; as a result, the smaller particle sizes can promote the higher surface qualities.

Hence, for the applications where surface roughness is critical it may be particularly advantageous to use the powder of the present disclosure with a minimum particle size often below to 300 μm.

In addition, laser, plasma or electron beam welding can be conducted using powder or wire made with the method of the present disclosure. Other powder metallurgy techniques wherein the metallic powder is produced according to the present disclosure may be powder metal injection molding, powder soldering, thermal spraying, cold spraying and spray forming.

Advantageously, part of the molten metal can be deposited on to a hot body, forming a near-net-shape solid. Near-net-shape solids or the ingots may be a bulk material and commercially typically are billets, rings, tubular products, and various other products. Depending on the application, the bulk material may be used in the as-deposited condition or it may undergo post-deposition processing.

The present disclosure further relates to a kit, comprising a bulk material originating from the ingot and metallic powder, wherein the bulk material and metallic powder are manufactured by the presently disclosed method. The deposition of the metallic droplets form an ingot, while non-deposited metallic droplets can be collected and classified as metallic powders of various ranges.

Hence, one of the advantage of the present disclosure may be to provide a kit comprising a bulk material and especially and preferably metallic powder originating from the same production process, metallic powder which is otherwise regarded as a scrap material.

Preferably, a kit may be provided for one or more metallic mold or die parts. The kit can comprise at least one ingot and metallic powder, wherein the ingot and metallic powder are originating from the same material source and they are manufactured simultaneously within the same manufacturing process. An advantage of this kit may be that it opens up the possibilities of obtaining materials in form of an ingot and powder, which are produced within a same process and can be delivered by a single source of provider.

In tool making, the parts of the tools, molds or dies are manufactured from different processes, such as forming, subtractive manufacturing or additive manufacturing. The manufacturing process is determined based on the desired final properties of the parts, cost and material savings among other factors. After determining the manufacturing process, a raw material is obtained. The form of the raw material may differ from process to process, indicating that the raw material may be obtained through different processes. One of the disadvantage of using raw materials originating from different process techniques is that the material composition may differ. Even a slight difference in material composition between the parts of a tool may result in challenges in production such as fracture of the tool parts.

One of the main advantages of the presently disclosed kit is to provide at bulk material and powder material of same material composition, which are suitable for being processed by conventional manufacturing techniques and powder metallurgy. Conventional manufacturing techniques can be a variety of manufacturing methods that are used and accepted in the manufacturing field by many users. This means that the kit provides a flexibility around the choice of manufacturing process to manufacture tool parts, molds and dies.

Accordingly, the present disclosure further relates to a metallic product or a tool in the form of a mold or a die. In a further advantageous embodiment, at least a first part of the mold or die is manufactured by at least one conventional manufacturing method. The conventional manufacturing method can be a conventional subtractive manufacturing technique, such as milling, drilling or it can be a forming process, preferably a bulk forming process, such as forging, rolling. Alternatively, the bulk material can be provided and used as produced. Furthermore, at least a second part of the mold or die is fabricated by a powder metallurgy technique, such as additive manufacturing, wherein the first and the second parts are made of same metal or alloys and originate from a manufacturing process according to the method of presently disclosed approach.

In a further embodiment, at least a first part of the product is obtained from subtractive manufacturing of an ingot, and at least a second part of the product is fabricated by additively depositing the powder, on the first part of the product, wherein the ingot and the powder are manufactured according to the method of the present disclosure, such that the ingot and the powder are from the same production run and are 1:1 compatible. Thus, a single product can be manufactured by a variety of starting-state components, such as bulk and powder and by a variety of manufacturing processes, such as machining and AM; consequently, physical and mechanical properties of the product can be controlled and enhanced.

System

Furthermore, the present disclosure relates to a system for producing a metallic ingot and metallic powder. The system comprises a source of metal or metal alloy, an atomizing unit for gas atomizing one or more streams of metal or metal alloy and a rotatable hot body. The system is configured such that one or more sprays of atomized droplets are formed and are directed through a nozzle towards the hot body suitable for receiving the spray(s) of droplets. In an embodiment, a part of the droplets adhere to the hot body, e.g., deposited to the hot body and form the ingot and part of the droplets bounce off of the hot body and form powder particles.

The system further comprises a classification unit configured to collect metallic powder within a predefined size distribution, and a control unit. The control unit can be configured to control the parameters such as the temperature of the metal or metal alloy, inlet and outlet pressure of the spray nozzle, the rotation speed of the hot body, and the distance between the hot body and the spray(s) of droplets.

In an embodiment, the system further comprises a control system. The control system may be for example an image-processing control system that captures the high-speed camera images of the hot body. Preferably, the control system can change the process variables to control the size and temperature of the hot body. An alternative for such a control system may be an AI system. This means that real time actual measures of the temperature and size of the hot body can be used to control the initially defined temperature and size of the hot body such that the selected or defined process parameters are varied by the AI system. It should be noted that the system preferably can be configured to execute the methods disclosed herein.

In an embodiment, the metallic powder size is measured during spray forming, such that by controlling the process parameters, a predefined metallic powder size distribution can be achieved. The measurement may be performed by means of a laser-based sensor. The system can thereby be configured to optimize the yield of the production through the use of laser-based sensors to identify the particle size of the overspray during spray forming process. The overspray may be preferably solidified by the time it reaches the bottom of the spray forming chamber and the measured particle size can be used as a criteria to change the process parameters until a suitable size distribution is achieved.

In an embodiment, the diameter of the hot body is measured during spray forming, such that a predefined diameter of the hot body can be achieved through controlling the process parameters. Measuring the diameter of the hot body during the process can advantageously be suitable for optimizing the yield of powder. Preferably, at least one thermal camera can be provided to acquire images of the hot body. Specifically, the acquired image(s) can be corrected via a correction framework through algorithms for machine vision to define the actual diameter of the hot body. Process parameters can then be changed until a predefined hot body size is achieved.

### DETAILED DESCRIPTION OF DRAWINGS

The present disclosure will now be described more fully hereinafter with

reference to the accompanying exemplary embodiments shown in the drawings when applicable. However, it is to be noted that the presently disclosed system and method may be embodied in various forms. The hereby provided embodiments are to guide a thorough and complete disclosure. Hence, embodiments set forth herein should not be interpreted as limiting but be construed as a tool for delivering the scope of the disclosure to those who are skilled in the art. Same reference numbers refers to the same element throughout the document.

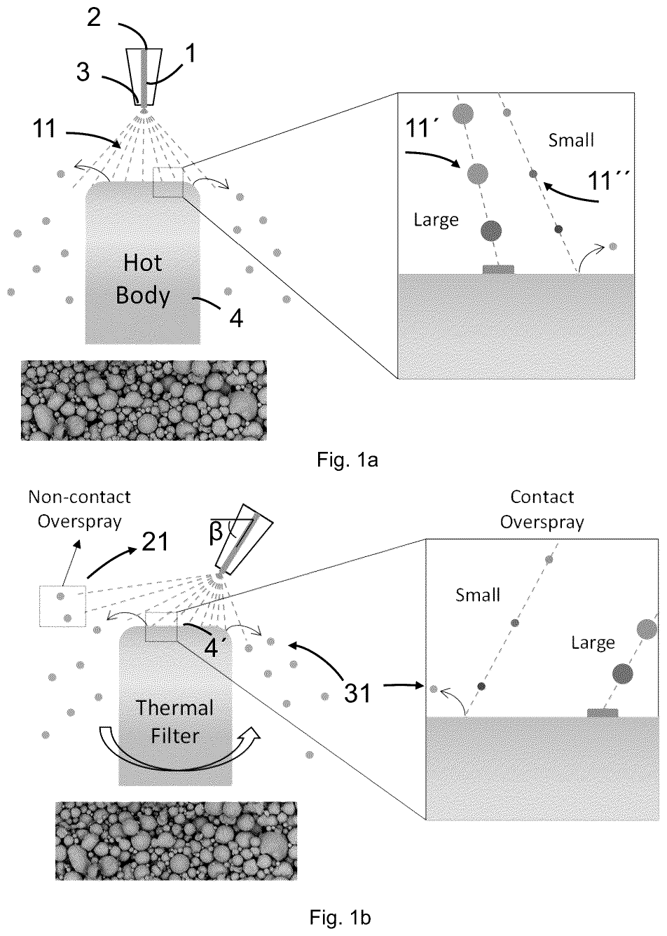

FIG. 1a shows one embodiment of the presently disclosed spray forming system for producing a metallic ingot and metallic powder. A stream of metal or molten metal 1 is provided through a nozzle having an inlet 2 and outlet 3 and the molten metallic source is sequentially atomized into a spray of fine droplets 11. The nozzle outlet 3 is provided directly above a top surface 4′ of a hot body 4, spraying substantially along and above said top surface 4′. The metallic droplets 11 are deposited on the hot body 4 at elevated temperature. The consolidation of the droplets are primarily governed by the nature of the spray and the thermal state of droplets, such that the droplets with larger particle size 11′ and a high latent heat are deposited on the hot body 4, while the smaller droplets 11″ with lower latent heat bounce off of the hot body.

FIG. 1b shows another embodiment of the presently disclosed spray forming system for producing a metallic ingot and metallic powder. The process is arranged such that the outlet 3 of the nozzle is positioned such that the atomized metallic droplets are directed onto a substrate or hot body 4 with a relative angle β to the top surface 4′ of the hot body. While the substrate rotates, consolidation of droplets on the substrate forms an ingot. As the deposition continues the hot body moves downwards giving the flexibility of forming ingots of various sizes.

Similar to what was shown in FIG. 1a, droplets strike the substrate whilst in the semi-solid condition such that, metallic droplets with a sufficient liquid fraction to the solid fraction, typically larger droplets, are deposited while the droplets with higher solid fraction, typically smaller droplets form powder particles. The droplets that encounter the hot body but do not stick to the hot body are referred as Contact overspray (COS) 31. Metallic droplets 11 that do not interact with the hot body and therefore are similar to gas-atomized powder 11 and referred as Non-contact overspray (NCOS) 21. From one aspect, the hot body 4 acts as a thermal filter as the larger powder particles are deposited on the hot body 4.

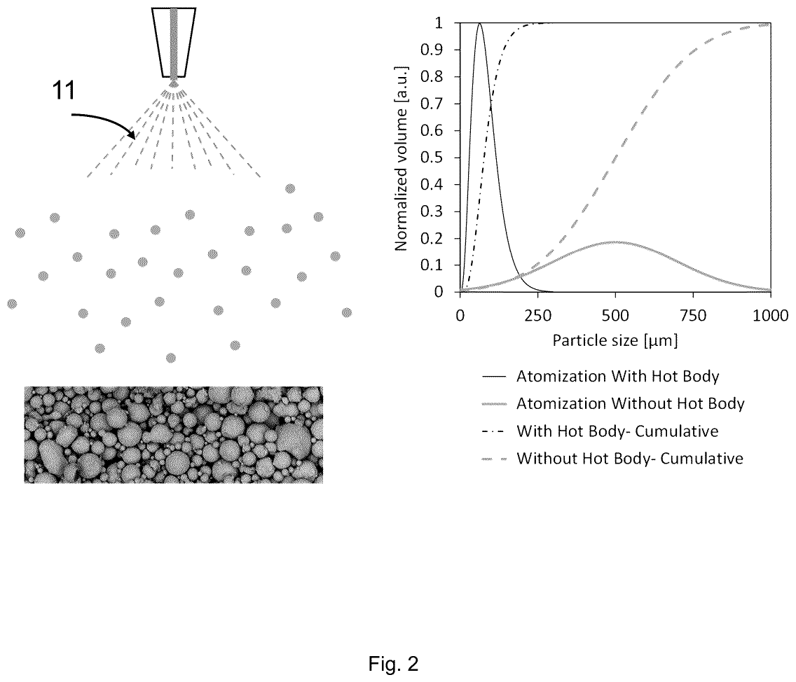

FIG. 2 shows one example of a particle size distribution of the metallic powder produced with and one without hot body. In conventional techniques for powder production such as gas atomization, the particle size can vary up to 1000 μm, whereas when the gas atomization unit is used simultaneously in connection with a hot body, the particle size decreases up to 250 μm. This is due to the deposition of the larger particles on the hot body as shown in FIG. 1a and FIG. 1b.

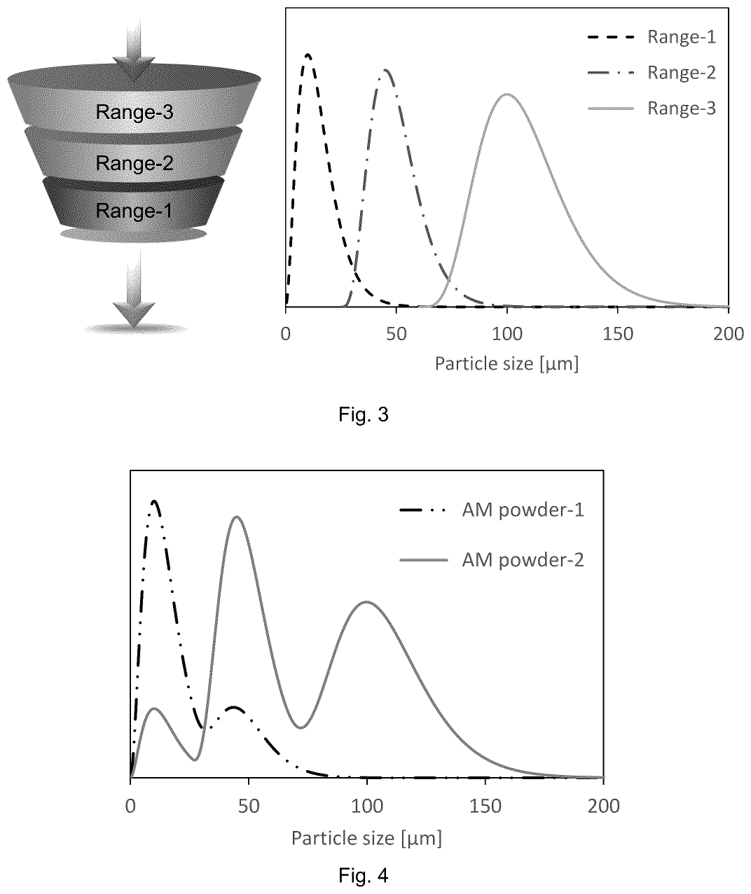

FIG. 3 shows an example illustration of a sorting station. In an advantageous embodiment of a spray forming system according to the present disclosure may be provided such sorting station. The station as shown comprises three step filtering system for sorting the metallic powder in three ranges; range-1, range-2 and range-3. The coarser powders with a size distribution between 75-200 μm are sorted first and classified as range-3. The powder particles with a particle size between 25-100 μm are sorted by the second station and classified as range-2. A few powders having a particle size larger than 75 μm and having been not sorted at the first sorting station are also classified as range-2. Finally, powder particles smaller than 50 μm, mostly smaller than 25 μm are classified as range-1.

FIG. 4 is one example of tailored powders having at least two ranges of powder particle size. AM Powder-1 is combination of range-1 and range-2 powders. This combination may be at various percentages. In an example, AM powder-1 corresponds to combination of 80% of range-1 powders and 20% of range-2 powders. AM Powder-2 is combination of range-1, range-2 and range-3 powders. In an example, AM powder-2 is combination of 10% of range-1 powders, 55% of range-2 powders and 35% of range-3 powders. The combination of different ranges at a given percentage can be defined in accordance with the process wherein the powder particles will be used.

### EXAMPLES

The present disclosure will now be described with reference to examples.

Defining a Powder Yield

Atomization parameters: Pressure at the spray nozzle inlet is between 3 bar-4 bar, at the spray nozzle outlet is between 12 bar-16 bar.

Hot body parameters: Position of the top of the hot body in relation to the spray is between 150 mm-250 mm, speed of rotation of the hot body is between 1.5 rad/s-3.5 rad/s, and speed of downward movement of the hot body is 70 mm/min.

Melt parameters: The temperature of the melt is 1680° C., angle of melt furnace tilt is 80-90°.

The target melt temperature is 1200° C., and the target ingot diameter is 0.46 m, which is smaller and colder than the typical spray forming that optimizes ingot volume, wherein the hot body is maintained at around 1330° C. with 0.5 m diameter. This would reduce the ingot yield from around 80% to around 70% and increase the powder yield from around 20% to around 30%.

Controlling the Parameters

### Example—1

If the hot body size is 0.5 m and temperature 1300° C., then the speed is increased from 60 mm/min until the real-time AI system measures the size to be 0.46 m in diameter, which is expected to occur at a speed of −70 mm/min.

### Example—2

If the hot body size is 0.5 m and the temperature 1300° C., then the atomization pressure is increased from 12 bar to 16 bar on the outlet while keeping the speed at 60 mm/min.

Furthermore, in order to demonstrate the impact of the process parameters on the quality of the resulting metal powders from the hereby disclosed spray forming method, two experiments (Example 3 an Example 4) have been run. The process parameters and experimental results are discussed here below.

### Example—3

The disclosed spray forming process has been run under following conditions:
Inlet pressure of the atomizer: 2-2.5 bar
Vertical speed of retraction of the ingot: 42-50 mm/min.
Rotational speed of the ingot: 6.3 rad/s.
Process measurements
Temperature at the top of the hot body: 1250° C., wherein the hot body is a cylindrical ingot with uniform diameter of 510 mm.

### Example—4

In order to produce finer and more spherical powders, the process parameters of disclosed spray forming method were as follows:
Inlet pressure of the atomizer: 2-2.5 bar
Vertical speed of retraction of the ingot: 56-66 mm/min.
Rotational speed of the ingot: 6.3 rad/s.
Process measurements
Temperature at the top of the hot body: 1350° C., wherein the hot body is a cylindrical ingot with uniform diameter of 500 mm.

Compared to the Example—4, the Example—3 was conducted with a lower temperature at the top of the ingot (1250° C.) while maintaining a (larger) ingot diameter (510 mm), with a (lower) vertical retraction speed (42-50 mm/min), with a (lower) secondary atomizer pressure (6 bar), while the primary atomizer and the rotational speed were constant for both experiments.

Laser Diffraction measurements coupled with X-ray CT scan measurements and scanning electron microscopy were used to identify the particle size distribution and powder morphology (measured here as spherecity) for both Example—3 and Example—4.

Generally, spray formed powders can be classified into two types: spherical morphology as shown in FIG. 6a and irregular morphology as shown in FIG. 6b.

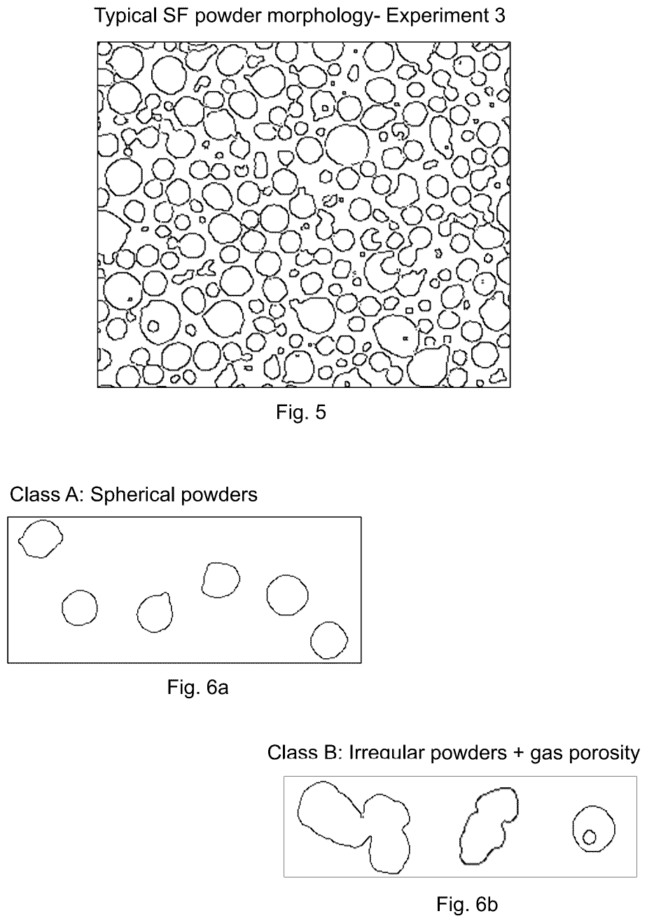

An example powder morphology of Example—3 is shown in FIG. 5. Example—3 produced a comparatively coarse particle size distribution. In Example—3, approximately 70% of the particles were classified as spherical when using a threshold of spherecity larger than 0.9.

According to the present disclosure, the process parameters (referred above) used in Example—4 lead to higher amounts of non-contact overspray powder (NCOS) in the small particle size range (0-60 μm) while simultaneously reducing the contact overspray powder (COS) in the larger particle size range (>60 μm).

Example—4 produced a finer particle size distribution on average ˜20% lower than Example—3 as measured from a normal/Gaussian distribution, while maintaining a better particle morphology. In Example—4, more than 85% of particles were classified as spherical, demonstrating an improvement in powder size and shape in Example—4, as compared to Example—3.

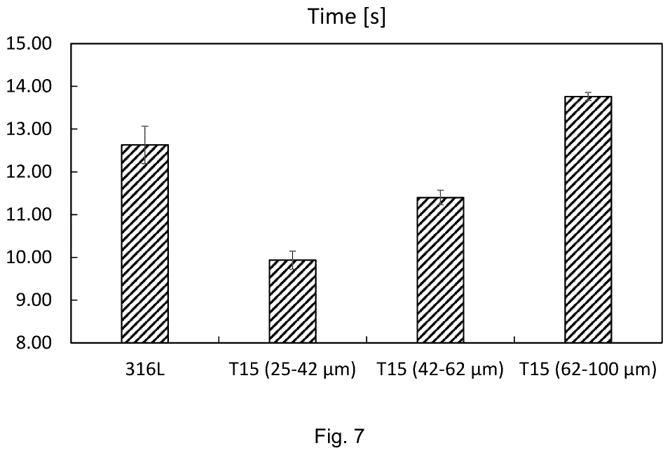

The optimized powder from Example—4 was sieved into multiple particle size distributions and compared with a powder obtained by a different commercially available process for manufacturing spherical powders, known as gas atomization. The flowability of the optimized powders (T15) from Example—4 was compared with flowability of the commercially available powder (316L) in FIG. 7. The flowability of the powders were measured by hall flow meter according to ASTM B213-20. As shown in FIG. 7, the optimized powders can generally flow faster, indicating an improved flowability. In this example, flowability is improved for particles having a particle size between 25-62 μm.

The powder, manufactured according to the present disclosure, when compared to a commercially available powder for additive manufacturing, can generally have better flowability due to its higher mean spherecity and better morphology. The improved particle size and particle shape of above described experiments can lead to an improved functionality of the powder for example through better flowability, which can be crucial for several manufacturing processes such as laser-powder bed fusion, electron beam powder bed fusion, laser cladding, directed energy deposition etc.

Based on the experiments disclosed above, it can be concluded that the hot body, such as an ingot, can play a critical role in the powder morphology. Furthermore, process parameters of the disclosed spray forming method can offer a control on the produced powders.

Kit

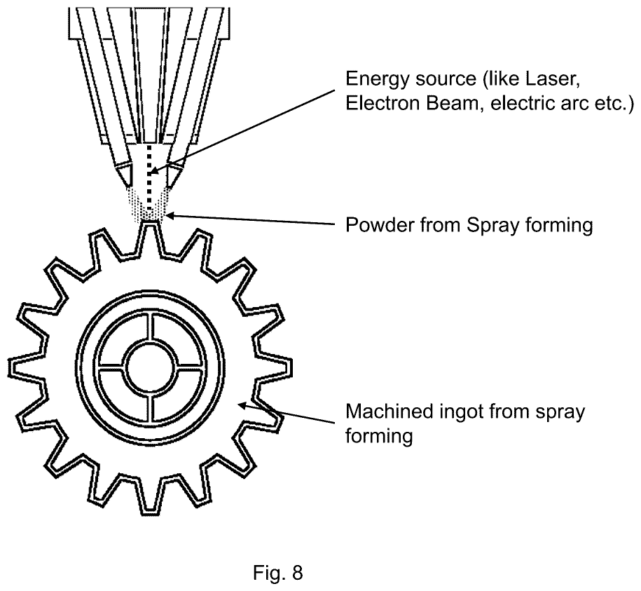

A bulk material and metallic powder manufactured according to the present disclosure can be used as a kit in many ways. At least a first part of the product can be obtained from subtractive manufacturing, e.g., machining of an ingot. FIG. 8 shows an example of a component that was made from the Spray Formed (SF) ingot and processed further through machining processes. The SF powder, the powder manufactured according to the present disclosure, can be used to deposit material in an additive fashion, commonly referred as Additive Manufacturing (AM) or 3D printing, to build on top of the manufactured component. Thus, at least a second part of the product can be fabricated by additively depositing the powder, on the machined ingot, wherein the ingot and the powder are manufactured according to the method of the present disclosure and the ingot and the powder are from the same production run and are 1:1 compatible. By combining subtractive and additive manufacturing methods for manufacturing of a single product, control of the properties, such as mechanical properties, of the product is enhanced.

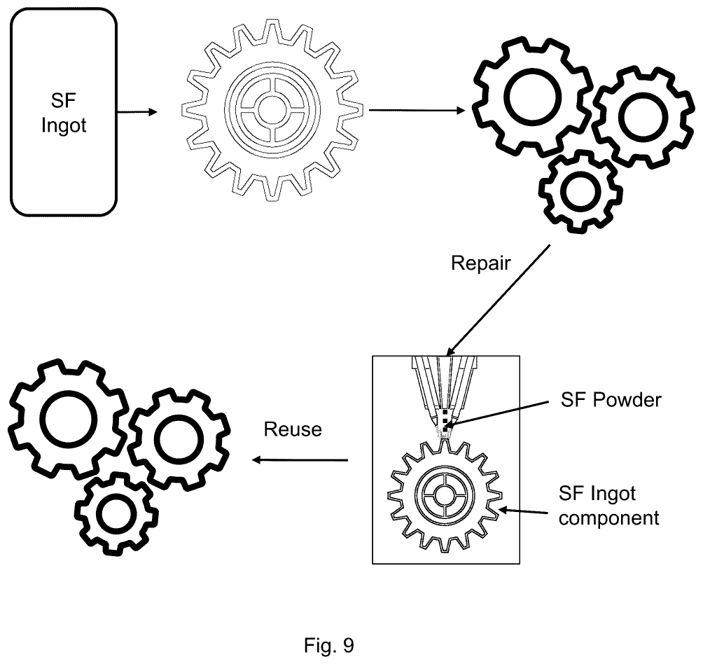

FIG. 9 is an example application of the kit wherein a component is made from an SF ingot, and is further put into service (as shown schematically by the three gear wheels; the shape, number and size of which are not limiting). At the end of its normal lifetime, the component is repaired using the 1:1 compatible powder from the same production run. This component can be reused multiple times using such a repair cycle.

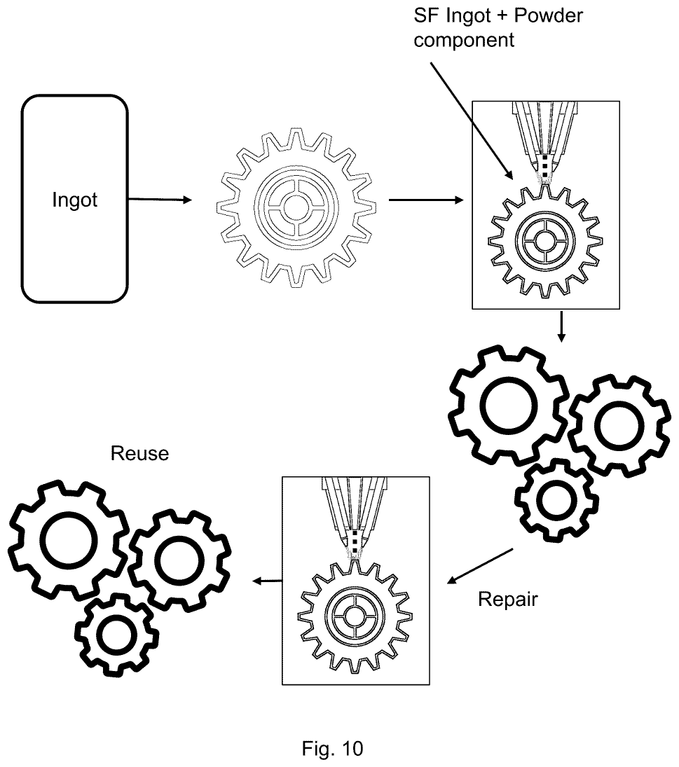

FIG. 10 is an example application of the kit wherein a component is made from an SF ingot+AM of SF powder of the same production run and is put into service. It is different from the one shown in FIG. 9 in that the product that is put into service is made from both ingot and powder from the same spray-forming run. At the end of its lifetime, the component is repaired using the 1:1 compatible powder from said same production run. Alternative to repairing the component to reach its previous state, the component can be further processed through AM, using the 1:1 compatible powder, for optimizing and/or altering the outer dimensions, mechanical properties etc. This component can be reused multiple times using such a cycle.

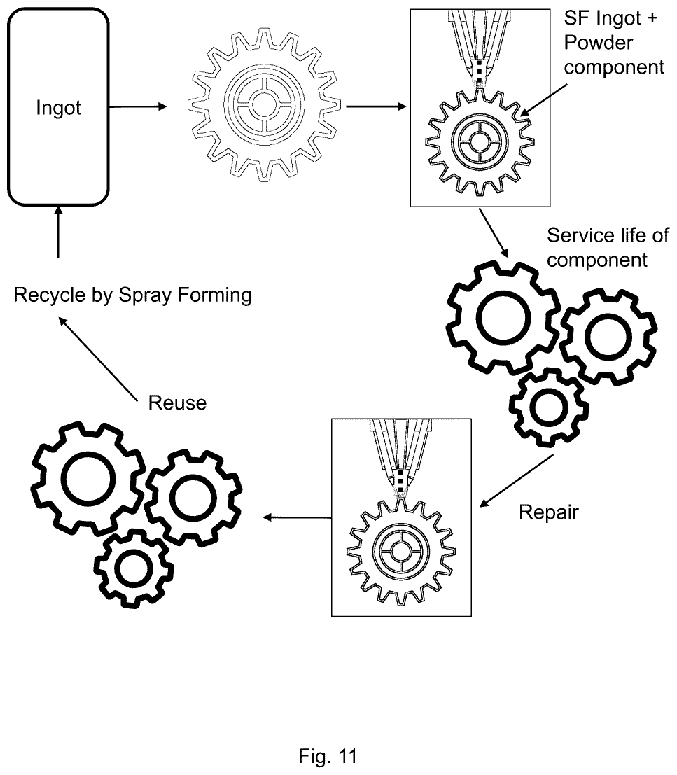

FIG. 11 is an example application of the kit, wherein a component is made from either an SF ingot or from an SF ingot+SF powder of the same run and is put into service. At the end of its lifetime, the component is repaired and reused multiple times. Once the cycle of repair and reuse is completed (due to the usage of all the 1:1 compatible SF powder), the component is recycled through the same SF process producing new ingots+powders thus creating a circular ecosystem.

Items
1. A spray forming method for producing a metallic ingot and metallic powder from a metallic source of metal or metal alloy, comprising the steps of:
forming one or more streams of metal or metal alloy from the metallic source,
gas atomizing the one or more streams of metal or metal alloy to form one or more sprays of atomized droplets,
directing the spray(s) of droplets through a spray nozzle to a rotatable hot body,
depositing the droplets to the hot body to form the ingot,
controlling the process parameters of 1) the temperature of metal or metal alloy, 2) inlet and outlet pressure of the spray nozzle, 3) the rotation speed of the hot body, and/or 4) the distance between the hot body and the spray(s) of droplets, and
collecting the metallic powder having a predefined size distribution, wherein the process parameters are controlled such that the ingot yield is between 60% and 80% and such that the metallic powder yield is between 40% and 20%, respectively, relative to the metallic source.
2. Method according to item 1, wherein the method comprises providing metallic powder particles such that a part of the droplets which bounces off from the hot body provides contact overspray (COS) metallic powder particles and another part of the droplets which does not contact with the hot body provides non-contact overspray (NCOS).
3. Method according to any of the preceding items, wherein the process parameters are controlled such that the ingot yield is between 60% and 80% and such that the metallic powder yield is between 20% and 40% relative to the metallic source.
4. Method according to any of the preceding items, wherein process parameters are controlled such that the ingot yield is between 68% and 72% and such that the metallic powder yield is between 28% and 32% relative to the metallic source.
5. Method according to any of the preceding items, wherein the temperature of the stream of metal or metal alloy is between 1500° C.-1700° C., preferably between 1600° C.-1700° C., most preferably between 1675° C.-1685° C.
6. Method according to any of the preceding items, wherein the pressure at the inlet of the spray nozzle is between 2 bar-4 bar, more preferably between 3 bar-4 bar.
7. Method according to any of the preceding items, wherein the pressure at the outlet of the spray nozzle is preferably between 12 bar-16 bar.
8. Method according to any of the preceding items, wherein the rotation speed of the hot body is between 0.5 rad/s-10 rad/s, preferably between 0.5 rad/s-5 rad/s, more preferably between 1.5 rad/s-3.5 rad/s.
9. Method according to any of the preceding items, wherein the distance between the hot body and the spray(s) of droplets are between 100 mm-300 mm, preferably between 150 mm-250 mm.
10. Method according to any of the preceding items, wherein temperature of the hot body is between 1100° C.-1500° C., preferably between 1150° C.-1400° C., more preferably between 1150° C.-1250° C., most preferably between 1175° C.-1225° C.
11. Method according to any of the preceding items, wherein the diameter of the hot body is between 0.2 m-0.8 m, more preferably between 0.3 m-0.7 m, even more preferably between 0.4 m-0.6 m, most preferably between 0.45 m-0.55 m.
12. Method according to any of the preceding items, wherein the provided powder particle size is below 300 μm, more preferably below 200 μm.
13. Method according to any of the preceding items 2-12, wherein the process parameters are controlled such that the COS yield is between 60% and 75% and such that the NCOS powder yield is between 40% and 25% relative to the metallic powder.
14. Method according to any of the preceding items 2-10, wherein the process parameters are controlled such that the COS yield is between 65% and 70% and such that the NCOS powder yield is between 35% and 30% relative to the metallic powder.
15. Method according to any of the preceding items, comprising the step of displacing the hot body transversally with a predefined vertical speed, such that the hot body moves downwards during spray forming.
16. Method according to item 15, wherein the vertical speed of the hot body is between 20 mm/min-200 mm/min, more preferably between 30 mm/min-150 mm/min, even more preferably between 40 mm/min-100 mm/min, most preferably between 60 mm/min-80 mm/min.
17. Method according to any of the preceding items, comprising the step of sorting the metallic powder to obtain one or more predefined powder particle size distribution(s).
18. Method according to any of the preceding items, wherein the powder particle size distributions is selected from the group of: 0-25 μm, 25-50 μm, 50-75 μm, 75-100 μm, 100-125 μm, 125-150 μm, 150-175 μm, 175-200 μm, 200-225 μm, 225-250 μm, 250-275 μm and 275-300 μm.
19. Method according to any of the preceding items, comprising the step of blending the metallic powder of at least one powder particle size distribution with metallic powder of at least a second powder particle size distribution.
20. Method according to any of the preceding items, further comprising the step of measuring the size of the metallic powder during spray forming, and controlling the process parameters accordingly in order to control the metallic powder size distribution.
21. Method according to any of the preceding items, further comprising the step of measuring the diameter of the hot body during spray forming, and controlling the process parameters accordingly in order to control the diameter of the hot body.
22. A method for manufacturing a metallic product using metal powder metallurgy, wherein the metal powder is manufactured according to the method of any of the items 1-21.
23. Use of a metallic powder in the application of powder metallurgy, wherein the metallic powder is manufactured by the method according to any of the items 1-21.
24. A method for manufacturing a metallic product using metal powder metallurgy, such as additive manufacturing or powder sintering, wherein the metal powder is manufactured by the method according to any of the items 1-21.
25. A kit, comprising a bulk material and metallic powder, manufactured by the method according to any of the items 1-21, wherein the bulk material is originating from the ingot and has a 1:1 material compatibility.
26. A kit for one or more metallic mold or die parts, comprising at least one ingot and metallic powder, wherein the ingot and metallic powder have same material composition and wherein the ingot and metallic powder are manufactured by the method according to any of the items 1-21.
27. A kit for one or more metallic mold or die parts, comprising an ingot and powder wherein the ingot and the powder are originating from the same material source and are manufactured simultaneously within the same manufacturing process according to the method of any of the items 1-21.
28. A metallic product in the form of a mold or die, wherein at least a first part of the mold or die is manufactured by at least one conventional manufacturing method such as subtractive manufacturing and at least a second part of the mold or die is fabricated by powder metallurgy, such as additive manufacturing, wherein the first and the second parts are made of same metal or alloys and originate from a manufacturing process according to the method of any of the items 1-21.
29. A metallic product, wherein at least a first part of the product is obtained from subtractive manufacturing of an ingot, and at least a second part of the product is fabricated by additively depositing the powder, on the first part of the product, wherein the ingot and the powder are manufactured according to the method of any of the items 1-21, such that the ingot and the powder are from the same production run and are 1:1 compatible.
30. A spray forming system for producing a metallic ingot and metallic powder, comprising:
a source of metal or metal alloy,
an atomizing unit for gas atomizing one or more streams of metal or metal alloy such that one or more sprays of atomized droplets are formed,
a rotatable hot body configured to receive the spray(s) of droplets directed by a spray nozzle, such that part of the droplets adhere to the hot body to form the ingot and part of the droplets bounce off of the hot body and form powder particles,
a classification unit configured to collect metallic powder within a predefined size distribution, and
a control unit configured to control 1) the temperature of the metal or metal alloy, and 2) inlet and outlet pressure of the spray nozzle, and 3) the rotation speed of the hot body, and 4) the distance between the hot body and the spray(s) of droplets.
31. System according to item 29, wherein the system classification unit further comprises a sorting station configured to sort the metallic powder in accordance with at least one or more powder size.
32. System according to items 29-30, wherein the classification unit further comprises a blending station configured to blend the metallic powder of at least one powder size with at least a second powder size.
33. System according to any of the preceding items, wherein the system is configured to execute the method of any of the items 1-21.

1. A spray forming method for producing a metallic ingot and metallic powder from a metallic source of metal or metal alloy, comprising the steps of:
forming one or more streams of metal or metal alloy from the metallic source,
gas atomizing the one or more streams of metal or metal alloy to form one or more sprays of atomized droplets,
directing the spray(s) of droplets through a spray nozzle to a rotatable hot body,
depositing the droplets to the hot body to form the ingot,
controlling the process parameters of 1) the temperature of metal or metal alloy, 2) inlet and outlet pressure of the spray nozzle, 3) the rotation speed of the hot body, and/or 4) the distance between the hot body and the spray(s) of droplets, and
collecting the metallic powder having a predefined size distribution,
wherein the process parameters are controlled such that the ingot yield is between 60% and 80% and such that the metallic powder yield is between 40% and 20%, respectively, relative to the metallic source.

2. Method according to claim 1, wherein the method comprises providing metallic powder particles such that a part of the droplets which bounces off from the hot body provides contact overspray (COS) metallic powder particles and another part of the droplets which does not contact with the hot body provides non-contact overspray (NCOS), and wherein the process parameters are controlled such that the COS yield is between 65% and 70% and such that the NCOS powder yield is between 35% and 30% relative to the metallic powder.

3. Method according to any of the preceding claims, wherein the process parameters are controlled such that the ingot yield is between 60% and 80% and such that the metallic powder yield is between 20% and 40% relative to the metallic source.

4. Method according to any of the preceding claims, wherein process parameters are controlled such that the ingot yield is between 68% and 72% and such that the metallic powder yield is between 28% and 32% relative to the metallic source.

5. Method according to any of the preceding claims, wherein the pressure at the inlet of the spray nozzle is between 3 bar-4 bar, and at the outlet of the spray nozzle is between 12 bar-16 bar.

6. Method according to any of the preceding claims, wherein the rotation speed of the hot body is between 0.5 rad/s-10 rad/s.

7. Method according to any of the preceding claims, wherein temperature of the hot body is between 1175° C.-1225° C.

8. Method according to any of the preceding claims, wherein the distance between the hot body and the spray(s) of droplets are between 150 mm-250 mm.

9. Method according to any of the preceding claims, wherein the diameter of the hot body is between 0.45 m-0.55 m.

10. Method according to any of the preceding claims, wherein the process parameters are controlled such that the COS yield is between 60% and 75% and such that the NCOS powder yield is between 40% and 25% relative to the metallic powder.

11. Method according to any of the preceding claims, wherein the provided powder particle size is below 200 μm.

12. Method according to any of the preceding claims comprising the step of displacing the hot body transversally with a predefined vertical speed, such that the hot body moves downwards during spray forming, wherein the vertical speed of the hot body is between 60 mm/min-80 mm/min.

13. Method according to any of the preceding claims, comprising the step of sorting the metallic powder to obtain one or more predefined powder particle size distribution(s), wherein the powder particle size distributions is selected from the group of: 0-25 μm, 25-50 μm, 50-75 μm, 75-100 μm, 100-125 μm, 125-150 μm, 150-175 μm, 175-200 μm.

14. A method for manufacturing a metallic product using metal powder metallurgy, wherein the metal powder is manufactured according to the method of any of the claims 1-13.

15. A kit, comprising a bulk material and metallic powder, manufactured by the method according to any of the claims 1-13, wherein the bulk material is originating from the ingot and has a 1:1 material compatibility.

16. A kit for one or more metallic mold or die parts, comprising an ingot and powder wherein the ingot and the powder are originating from the same material source and are manufactured simultaneously within the same manufacturing process according to the method of any of the claims 1-13.

17. A metallic product in the form of a mold or die, wherein at least a first part of the mold or die is manufactured by at least one subtractive manufacturing method and at least a second part of the mold or die is fabricated by powder metallurgy, such as additive manufacturing, wherein the first and the second parts are made of same metal or alloys and originate from a manufacturing process according to the method of any of the claims 1-13.

18. A metallic product, wherein at least a first part of the product is obtained from subtractive manufacturing of an ingot, and at least a second part of the product is fabricated by additively depositing the powder, on the first part of the product, wherein the ingot and the powder are manufactured according to the method of any of the claims 1-13, such that the ingot and the powder are from the same production run and are 1:1 compatible.

19. A spray forming system for producing a metallic ingot and metallic powder, comprising:
a source of metal or metal alloy,
an atomizing unit for gas atomizing one or more streams of metal or metal alloy such that one or more sprays of atomized droplets are formed,
a rotatable hot body configured to receive the spray(s) of droplets directed by a spray nozzle, such that part of the droplets adhere to the hot body to form the ingot and part of the droplets bounce off of the hot body and form powder particles,
a classification unit configured to collect metallic powder within a predefined size distribution, and
a control unit configured to control 1) the temperature of the metal or metal alloy, and 2) inlet and outlet pressure of the spray nozzle, and 3) the rotation speed of the hot body, and 4) the distance between the hot body and the spray(s) of droplets,
wherein the system is configured to execute the method of any of the claims 1-13.

20. The system according to claim 19, wherein the classification unit further comprises a sorting station configured to sort the metallic powder in accordance with at least one or more powder size, and a blending station configured to blend the metallic powder of at least one powder size with at least a second powder size.
